(19) United States
(12) Patent Application Publication
(10) Pub. No.: US 2022/0217976 A1
(43) Pub. Date: Jul. 14, 2022

(54) NEW MICROCAPSULES FOR AGRICULTURAL APPLICATIONS

(71) Applicant: BASF SE, Ludwigshafen (DE)

(72) Inventors: Roland Hinrich Staff, Ludwigshafen (DE); Joanna Mecfel-Marczewski, Limburgerhof (DE); Martin Semar, Limburgerhof (DE); Christian Sowa, Limburgerhof (DE); John M. Brausch, Research Triangle Park, NC (US); Gerhard Peter Dohmen, Limburgerhof (DE); Bernd Dieter Oschmann, Ludwigshafen (DE); Joerg Braun, Limburgerhof (DE)

(21) Appl. No.: 17/424,614

(22) PCT Filed: Jan. 31, 2020
(86) PCT No.: PCT/EP2020/052383

§ 371 Date: Jul. 21, 2021

(30) Foreign Application Priority Data
Feb. 4, 2019 (EP) 19155188.6

(51) Int. Cl. A01N 25/28; A01N 25/18; A01N 43/56; A01N 59/00; B01J 13/16; A01P 3/00

(52) U.S. Cl. CPC A01N 25/28; A01N 25/18; A01P 3/00; A01N 59/00; B01J 13/16; A01N 43/56

(57) ABSTRACT

Microcapsule comprising a shell and a core, wherein said core comprises a pesticide and a water immiscible solvent and wherein said shell comprises an organic polymer, wherein said microcapsule further comprises a protective colloid of silica particles.

The present invention is related to microcapsules comprising a shell and a core, wherein said core comprises a pesticide and a water immiscible solvent and wherein said shell comprises an organic polymer, wherein said microcapsule further comprises a protective colloid of silica particles.

Microcapsules comprising a polyurea or poly(meth)acrylate shell and a core, which contains a pesticide and solvents are known:

EP 0619073 discloses polyurea microcapsules encapsulating a water-immiscible pesticide. Suitable solvents in which the pesticide is dissolved are for example mineral oil or cyclohexanone.

EP 0611253 discloses polyurea capsules encapsulating a water-immiscible pesticide. Suitable solvents in which the pesticide is dissolved are for example aromatic hydrocarbons or cyclohexanone.

EP 0747116 discloses polyurea capsules comprising a pesticide and a solvent, such as aromatic hydrocarbons or ketones.

U.S. Pat. No. 4,056,610 discloses polyurea microcapsules comprising a liquid fill, which contains a pyrethroid and water immiscible organic solvents, such as aromatic hydrocarbons or higher ketones.

WO2016199167 discloses microcapsules comprising clay nanoparticles.

There is a need for formulations, especially formulations comprising encapsulated pesticides that show a high efficiency in combating pests on the plants while at the same time having advantageous release properties and having minimal undesired side effects. For example, it is desirable to provide formulations that have reduced toxicity towards amphibians. It was an objective of the present invention to provide such capsules and formulations.

This objective has been achieved by microcapsules comprising a shell and a core, wherein said core comprises a pesticide and a water immiscible solvent and wherein said shell comprises an organic polymer, wherein said microcapsule further comprises a protective colloid of silica particles.

The term “pesticide” as used herein shall mean any pesticidally active compound including herbicides, insecticides, fungicides, growth regulators, safeners.

Preferably, such pesticide is pyraclostrobin.

The core of microcapsules according to the invention comprises a water immiscible solvent and a pesticide, preferably pyraclostrobin.

Typically, pesticide, preferably pyraclostrobin is comprised in the core of microcapsules according to the invention in an amount from 5 to 70 wt %, preferably 10 to 60 wt %.

The core of such microcapsules comprises a water-immiscible solvent. The water-immiscible solvent may be soluble in water at 20° C. up to 50 g/l, preferably up to 20 g/l, more preferably up to 5 g/l and especially preferably up to 1 g/l.

Suitable examples for water-immiscible solvents are
a hydrocarbon solvent such as aliphatic, cyclic and aromatic hydrocarbons (e. g. toluene, xylene, paraffin, tetrahydronaphthalene, alkylated naphthalenes or their derivatives, mineral oil fractions of medium to high boiling point (such as kerosene, diesel oil, coal tar oils));
a vegetable oil such as corn oil, rapeseed oil;
esters of carboxylic acids, especially dicarboxylic acids such as benzyl acetate, dibutyl adipate, dibutyl succinate, dibutyl phthalate
a fatty acid ester such as C₁-C₁₀-alkylester of a C₁₀-C₂₂-fatty acid; or
methyl- or ethyl esters of vegetable oils such as rapeseed oil methyl ester or corn oil methyl ester
aliphatic C₆-C₁₈ alcohols, preferably C8-C14 alcohols, bearing a primary, secondary or tertiary hydroxyl group, such as n-decanol, n-undecanol, n-dodecanol

Mixtures of aforementioned solvents are also possible. Preferred solvents are aromatic hydro-carbons.

Suitable water-immiscible solvents are aromatic hydrocarbons. Aromatic hydrocarbons are compounds which consist of carbon and hydrogen and which comprise aromatic groups. Preferred are aromatic hydrocarbons or their mixtures with an initial boiling point of at least 160° C., preferably at least 180° C. Examples of aromatic hydrocarbons are benzene, toluene, o-, m- or p-xylene, naphthalene, biphenyl, o- or m-terphenyl, aromatic hydrocarbons which are mono- or poly-substituted by C₁-C₂₀-alkyl, such as ethylbenzene, dodecylbenzene, tetradecylbenzene, hexadecylbenzene, methylnaphthalene, diisopropylnaphthalene, hexylnaphthalene or decylnaphthalene. Others which are suitable are aromatic hydrocarbon mixtures with an initial boiling point of at least 160° C. Preferred aromatic hydrocarbons are aromatic hydrocarbon mixtures with an initial boiling point of at least 160° C., preferably at least 180° C. Mixtures of the above aromatic hydrocarbons are also possible.

In another preferred embodiment said water-immiscible solvent is dibutyladipat.

In one embodiment, said pesticide is at least partly dissolved in said water immiscible solvent in said core of the microcapsule. In one embodiment, said pesticides is completely dissolved in said water-immiscible solvent in the core of the microcapsule at 20° C. Preferably, said pesticide, preferably pyraclostrobin, is completely dissolved in said water immiscible solvent at 20° C.

Microcapsules according to the invention comprise a capsule shell comprising an organic polymer. Said organic polymer can be any known shell material (e.g. Poly(meth)acrylates, polystyrenes, melamine formaldehyde condensates and polyaddition products of isocyanates, in particular polyureas and polyurethanes. Said organic polymer comprised in the shell is insoluble in water and insoluble in the said water immiscible solvent comprised in the core of the microcapsule. Said organic polymer making up the shell is preferably a polyurea or a poly(meth)acrylate. In one embodiment said organic polymer making up the shell is a poly(meth)acrylate. In one embodiment said organic polymer making up the shell is polyurea.

The term “insoluble” shall mean that a substance is soluble in a medium in an amount of less than 1 g/l at 20° C., preferably less than 0.1 g/l.

The term “(meth)acrylate” shall mean “methacrylate or acylate”.

Poly(meth)acrylate is a known shell material for microcapsules, for example from WO 2008/071649, EP 0 457154 or DE 10 2007 055 813. Usually, the poly(meth)acrylate comprises C₁-C₂₄ alkyl esters of acrylic and/or methacrylic acid, acrylic acid, methacrylic acid, and/or maleic acid in polymerized form. More preferably, the poly(meth)acrylate comprises methyl methacrylate and methacrylic acid. The poly(meth)acrylate may also comprise in polymerized form one or more difunctional or polyfunctional monomers. The poly(meth)acrylate may further comprise other monomers.

More preferably, the poly(meth)acrylate polymer is synthesized from
30 to 100 wt %, based on the total weight of the monomers, of one or more monomers (monomers I) from the group comprising C₁-C₂₄ alkyl esters of acrylic and/or methacrylic acid, acrylic acid, methacrylic acid, and maleic acid,
10 to 70 wt %, based on the total weight of the monomers, of one or more difunctional or polyfunctional monomers (monomers II), and
0 to 40 wt %, based on the total weight of the monomers, of one or more other monomers (monomers III).

The poly(meth)acrylate of the capsule wall comprise generally at least 30%, in a preferred form at least 40%, in a particularly preferred form at least 50%, more particularly at least 60%, with very particular preference at least 70%, and also up to 100%, preferably not more than 90%, more particularly not more than 85%, and, with very particular preference, not more than 80%, by weight, of at least one monomer from the group comprising C₁-C₂₄ alkyl esters of acrylic and/or methacrylic acid, acrylic acid, methacrylic acid, and maleic acid (monomers I), in copolymerized form, based on the total weight of the monomers.

Furthermore, the poly(meth)acrylate of the capsule wall comprises preferably at least 10%, preferably at least 15%, preferentially at least 20%, and also, in general, not more than 70%, preferably not more than 60%, and with particular preference not more than 50%, by weight, of one or more difunctional or polyfunctional monomers (monomers II), in copolymerized form, based on the total weight of the monomers. In another preferred embodiment, the poly(meth)acrylate of the capsule wall comprises preferably at least 10%, preferably at least 15%, and also, in general, not more than 50%, preferably not more than 40% by weight, of one or more polyfunctional monomers (monomers II), in copolymerized form, based on the total weight of the monomers.

Additionally, the poly(meth)acrylate may comprise up to 40%, preferably up to 30%, more particularly up to 20%, by weight, of other monomers III, in copolymerized form. The capsule wall is preferably synthesized only from monomers of groups I and II.

Suitable monomers I are C₁-C₂₄ alkyl esters of acrylic and/or methacrylic acid and also the unsaturated C₃ and C₄ carboxylic acids such as acrylic acid, methacrylic acid, and also maleic acid. Suitable monomers I are isopropyl, isobutyl, sec-butyl, and tert-butyl acrylates and the corresponding methacrylates, and also, with particular preference, methyl, ethyl, n-propyl, and n-butyl acrylates and the corresponding methacrylates. In general, the methacrylates and methacrylic acid are preferred. In one embodiment, monomers I include hydroxy substituted alkyl (meth)acrylates such as 2-hydroxyethylmethacrylat.

Suitable monomers II are difunctional or polyfunctional monomers. By difunctional or polyfunctional monomers are meant compounds which have at least two nonconjugated ethylenic double bonds. Contemplated primarily are divinyl monomers and polyvinyl monomers. They bring about crosslinking of the capsule wall during the polymerization. In another preferred embodiment, suitable monomers II are polyfunctional monomers.

Suitable divinyl monomers are divinylbenzene and divinylcyclohexane. Preferred divinyl monomers are the diesters of diols with acrylic acid or methacrylic acid, and also the diallyl and divinyl ethers of these diols. Mention may be made, by way of example, of ethylene glycol diacrylate, ethylene glycol dimethacrylate, 1,3-butylene glycol dimethacrylate, methallylmethacrylamide, allyl acrylate, and allyl methacrylate. Particular preference is given to ethyleneglycol, 1,2-propanediol, 1,4-butanediol, 1,5-pentanediol, and 1,6-hexanediol diacrylates and the corresponding methacrylates.

Preferred polyvinyl monomers are the polyesters of polyols with acrylic acid and/or methacrylic acid, and also the polyallyl and polyvinyl ethers of these polyols, trivinylbenzene and trivinylcyclohexane. Particular preference is given to trimethylolpropane triacrylate and trimethacrylate, pentaerythritol triallyl ether, pentaerythritol tetraallyl ether, pentaerythritol triacrylate, and pentaerythritol tetraacrylate, and also their technical mixtures.

Monomers III contemplated are other monomers, different than the monomers I and II, such as vinyl acetate, vinyl propionate, vinylpyridine, and styrene or □-methylstyrene. Particular preference is given to itaconic acid, vinylphosphonic acid, maleic anhydride, 2-hydroxyethyl acrylate and methacrylate, acrylamido-2-methylpropanesulfonic acid, methacrylonitrile, acrylonitrile, methacrylamide, N-vinylpyrrolidone, N-methylolacrylamide, N-methylolmethacrylamide, dimethylaminoethyl methacrylate, and diethylaminoethyl methacrylate.

In one preferred embodiment, such poly(meth)acrylates making up the shell of such microcapsules according to the invention comprise one or more of ethylene glycol dimethacrylate, methylmethacrylate, methacrylic acid, 2-hydroxy ethyl methacrylate, pentaerythritol triacrylate, 1,4-butane diol diacrylate, polyethylene glycol diacrylate.

In one preferred embodiment, such poly(meth)acrylates making up the shell of such microcapsules according to the invention only comprise ethylenically unsaturated monomers selected from one or more of ethylene glycol dimethacrylate, methylmethacrylate, methacrylic acid, 2-Hydroxy ethyl methacrylate, pentaerythritol triacrylate, 1,4-butane diol diacrylate, polyethylene glycol diacrylate.

In one embodiment the shell of such microcapsules according to the invention comprise methyl methacrylate and pentaerythritol triacrylate.

In one embodiment the shell of such microcapsules according to the invention comprise methyl methacrylate, pentaerythritol triacrylate, 1,4-butane diol diacrylate and methacrylic acid.

In one embodiment the shell of such microcapsules according to the invention comprise methyl methacrylate methacrylic acid, 2-Hydroxy ethyl methacrylate and ethylene glycol dimethacrylate.

In one embodiment the shell of such microcapsules according to the invention comprise methyl methacrylate, pentaerythritol triacrylate, 1,4-butane diol diacrylate and methacrylic acid.

In one embodiment the shell of such microcapsules according to the invention comprise methyl methacrylate, methacrylic acid, 2-hydroxy ethyl methacrylate and ethylene glycol dimethacrylate.

In one embodiment the shell of such microcapsules according to the invention comprise methyl methacrylate and pentaerythritol triacrylate and no other ethylenically unsaturated monomers.

In one embodiment the shell of such microcapsules according to the invention comprise methyl methacrylate, pentaerythritol triacrylate, 1,4-butane diol diacrylate and methacrylic acid and no other ethylenically unsaturated monomers.

In one embodiment the shell of such microcapsules according to the invention comprise methyl methacrylate methacrylic acid, 2-hydroxy ethyl methacrylate and ethylene glycol dimethacrylate and no other ethylenically unsaturated monomers.

In one embodiment the shell of such microcapsules according to the invention comprise methyl methacrylate, pentaerythritol triacrylate, 1,4-butane diol diacrylate and methacrylic acid and no other ethylenically unsaturated monomers.

In one embodiment the shell of such microcapsules according to the invention comprise methyl methacrylate, methacrylic acid, 2-hydroxy ethyl methacrylate and ethylene glycol dimethacrylate and no other ethylenically unsaturated monomers.

When reference is made herein to a shell or any other polymer “comprising” an ethylenically unsaturated monomer, this shall mean that said ethylenically unsaturated monomer is comprised in said polymer in polymerized form.

Polyurea is also a known shell material for microcapsules. They are preferably prepared by an interfacial polymerization process of a suitable polymer wall forming material, such as a polyisocyanate and a polyamine. Interfacial polymerization is usually performed in an aqueous oil-in-water emulsion or suspension of the core material containing dissolved therein at least one part of the polymer wall forming material. During the polymerization, the polymer segregates from the core material to the boundary surface between the core material and water thereby forming the wall of the microcapsule. Thereby an aqueous suspension of the microcapsule material is obtained.

In general, polyurea is formed by reacting a polyisocyanate having at least two isocyanate groups with a polyamine having at least two primary amino groups to form a polyurea wall material. However, preferred is if either the polyisocyanate or the polyamine or both have more than two reactive —NCO- or NH-groups, respectively. In a further embodiment, the polyurea may be formed by contacting polyisocyanate with water. Also, and preferably, the polyurea results from a reaction of polyisocyanate with both polyamine and water. Preferably, the polyurea shell contains a polyisocyanate and a polyamine in polycondensed form. Suitable polyisocyanates are known, e.g. from US 2010/0248963 A1, paragraphs [0135] to [0158], to which full reference is made. Suitable polyamines are known, e.g. from US 2010/0248963 A1, paragraphs [0159] to [0169], to which full reference is made.

Polyisocyanates may be used individually or as mixtures of two or more polyisocyanates. Suitable polyisocyanates are for example aliphatic isocyanates or aromatic isocyanates. These isocyanates may be present as monomeric or oligomeric isocyanates. The NCO content may be determined according to ASTM D 5155-96 A.

Examples of suitable aliphatic diisocyanates include tetramethylene diisocyanate, pentamethylene diisocyanate and hexamethylene diisocyanate as well as cycloaliphatic isocyanates such as isophorone diisocyanate, 1,4-bisisocyanatocyclohexane and bis-(4-isocyanatocyclohexyl)methane.

Suitable aromatic isocyanates include toluene diisocyanates (TDI: a mixture of the 2,4- and 2,6-isomers), diphenylmethene-4,4′-diisocyanate (MDI), polymethylene polyphenyl isocyanate, 2,4,4′-diphenyl ether triisocyanate, 3,3′-dimethyl-4,4′-diphenyl diisocyanate, 3,3′-dimethoxy-4,4′-diphenyl diisocyanate, 1,5-naphthylene diisocyanate and 4,4′,4″-triphenylmethane triisocyanate. Also suitable are higher oligomers of the aforementioned diisocyanates such as the isocyanurates and biurets of the aforementioned diisocyanates and mixtures thereof with the aforementioned diisocyanates.

In another preferred embodiment, the polyisocyanate is an oligomeric isocyanate, preferably an aromatic or aliphatic, oligomeric isocyanate. Such oligomeric isocyanates may comprise above mentioned aliphatic diisocyanates and/or aromatic isocyanates in oligomerized form. Preferred aliphatic oligomeric isocyanates include isocyanurates, biurets or allophanates of 1,6-hexymethylenediisocyanate or isophoronediisocynate, preferred are isocyanurates of 1,6.-hexamethylenediisocyanate. Such oligomeric isocyanates, especially of hexamethylenediisocyanate, can optionally be functionalized with functional groups to improve the water dispersibility of such oligomers, such functional groups including polyethylene glycol chains or ionic groups such as sulfonate groups. The oligomeric isocyanates typically have an average functionality in the range of 2.0 to 4.0, preferably 2.1 to 3.2, and more preferably 2.3 to 3.0. Typically, these oligomeric isocyanates have a viscosity (determined according to DIN 53018) in the range from 20 to 1000 mPas, more preferably from 80 to 500 mPas and especially from 150 to 320 mPas. Such oligomeric isocyanates are commercially available, for example from BASF SE under the tradenames Lupranat® M10, Lupranat® M20, Lupranat® M50, Lupranat® M70, Lupranat® M200, Lupranat® MM103, Basonat®.

Also suitable are adducts of diisocyanates with polyhydric alcohols, such as ethylene glycol, glycerol and trimethylolpropane, obtained by addition, per mole of polyhydric alcohol, of a number of moles of diisocyanate corresponding to the number of hydroxyl groups of the respective alcohol and mixtures thereof with the aforementioned diisocyanates. In this way, several molecules of diisocyanate are linked through urethane groups to the polyhydric alcohol to form high molecular weight polyisocyanates. A particularly suitable product of this kind can be prepared by reacting three moles of toluene diisocyanate with one mole of 2-ethylglycerol (1,1-bis-methylolpropane). Further suitable products are obtained by addition of hexamethylene diisocyanate or isophorone diisocyanate with ethylene glycol or glycerol.

Preferred polyisocyanates are isophorone diisocyanate, diphenylmethane-4,4′-diisocyanate, toluene diisocyanates, and oligomeric isocyanates, whereas oligomeric isocyanates are in particular preferred.

Suitable polyamines within the scope of this invention will be understood as meaning in general those compounds that contain two and more amino groups in the molecule, which amino groups may be linked to aliphatic or aromatic moieties.

Examples of suitable aliphatic polyamines are □□□□-diamines of the formula H₂N—(CH₂)ₚ—NH₂, wherein p is an integer from 2 to 6. Exemplary of such diamines are ethylene diamine, propylene-1,3-diamine, tetramethylene diamine, pentamethylene diamine and hexamethylene diamine. A preferred diamine is hexamethylene diamine. Further suitable aliphatic polyamines are polyethyleneimines of the formula H₂N—(CH₂—CH₂—NH)_{q}—H, wherein q is an integer from 2 to 20, preferably 3 to 5. Representative examples of such polyethyleneimines are diethylene triamine, triethylene tetramine, tetraethylene pentamine and pentaethylene hexamine. Further suitable aliphatic polyamines are dioxaalkane-□□□□diamines, such as 4,9-dioxadodecane-1,12-diamine of the formula H₂N—(CH₂)₃O—(CH₂)₄O—(CH₂)₃—NH₂.

Examples of suitable aromatic polyamines are 1,3-phenylene diamine, 2,4- and 2,6-toluene diamine, 4,4′-diaminodiphenyl methane, 1,5-diaminonaphthalene, 1,3,5-triaminobenzene, 2,4,6-triaminotoluene, 1,3,6-triaminonaphthalene, 2,4,4′-triaminodiphenyl ether, 3,4,5-triamino-1,2,4-triazole and 1,4,5,8-tetraaminoanthraquinone. Those polyamines which are insoluble or insufficiently soluble in water may be used as their hydrochloride salts.

Polyamines, such as those mentioned above may be used individually or as mixtures of two or more polyamines. Preferred polyamine is a polyethyleneimine, such as tetraethylene pentamine.

The relative amounts of each complementary wall-forming component will vary with their equivalent weights. In general, approximately stoichiometric amounts are preferred, while an excess of one component may also be employed, especially an excess of polyisocyanate. The total amount of wall-forming components approximately corresponds to the total amount of polymeric wall-forming materials.

The microcapsules contain up to 30 wt %, preferably up to 25 wt % and in particular up to 20 wt % of shell (e.g. based on the total amount of pesticide, all solvents in the core, polyisocyanate, and polyamine, pol(meth)acrylate and not taking into account any protective colloid). The microcapsules contain usually at least 0.5 wt %, preferably at least 1.5 wt % shell. In another form the microcapsules contain up to 25 wt %, preferably up to 20 wt % and in particular up to 18 wt % of shell (e.g. based on the total amount pesticide, especially pyraclostrobin, all solvents in the core, polyisocyanate, and polyamine, poly(meth)acrylate).

Microcapsules according to the invention further comprise a protective colloid comprising silica particles. Such silica particles comprised in the protective colloid of the shell are smaller in average diameter (d50) than the microcapsules, typically by a factor of at least 20, preferably 50, more preferably 100.

Average particle sizes of silica particles comprised in the protective colloid of the shell are measured by light scattering according to DIN ISO 22412:2018-2. Average particle sizes of the inventive microcapsules and of other particles with particle sizes above 0.5 μm are measured by laser diffraction according to ISO 13320 (Particle Size Analysis—Laser Diffraction Methods, Dec. 1, 2009).

Suitable SiO₂-based protective colloids are highly disperse silicas, which can be dispersed in the form of fine, solid particles in water or can be used in the form of what are called colloidal dispersions of silica in water. Colloidal dispersions of this kind are alkaline, aqueous mixtures of silica. In the alkaline pH range the particles are swollen and stable in water. For the use of these dispersions as protective colloids it is advantageous if the pH of the oil-in-water emulsion is adjusted to 2 to 7 with an acid.

In one embodiment colloidal dispersions of silica have a specific surface area at a pH of 9.3 in the range from 50 to 300 m²/g.

In one embodiment colloidal dispersions of silica have a specific surface area at a pH of 9.3 in the range from 70 to 90 m²/g.

In one embodiment colloidal dispersions of silica have a specific surface area at a pH of 9.3 in the range from 150 to 300 m²/g.

In one embodiment, mixtures or disperse silica with bimodal particle size distributions are used.

Preferred SiO₂-based protective colloids are highly disperse silicas whose average particle size d₅₀ is in the range from 50 to 200 nm, preferably 10 to 150 nm at pH levels in the range of 8-11.

In one embodiment, suitable silica particles have an average particle size d₅₀ of 40 to 130 nm, at pH levels in the range of 8-11. In one embodiment, suitable silica particles have an average particle size d₅₀ of 5 to 30 nm, at pH levels in the range of 8-11.

In one embodiment, mixtures or disperse silica particles with different particle sizes are used.

In one embodiment, SiO2 based protective colloids have an average surface of 10 to 1000 m²/g, preferably 50 to 500 m²/g.

In one preferred embodiment, said protective colloid comprises silica particles and a stabilizing polymer SP.

Said stabilizing polymer SP stabilizes the protective colloid by binding the silica particles to said protective colloid through adhesive forces between the silica particles and said stabilizing polymer SP.

Said stabilizing polymer SP can in principle be any polymer with the ability to establish adhesive bonds with silica particles as well as the organic polymer comprised in the shell of microcapsules according to the invention. Therefore, stabilizing polymers SP normally have amphiphilic properties and bear hydrophilic as well hydrophobic groups. Examples of stabilizing polymers SP include polyvinyl alcohol and cellulose derivatives.

In one preferred embodiment, said protective colloid comprises silica particles and a cellulose derivative C as stabilizing polymer SP.

Preferably cellulose derivative C is methylhydroxy-(C₁-C₄)-alkylcellulose.

In one embodiment, a methylhydroxy-(C₁-C₄)-alkylcellulose is used which has an average molecular weight (weight average)≤50 000 g/mol, preferably from the range from 5 000 to 50 000 g/mol, preferentially from 10 000 to 35 000 g/mol, more particularly 20 000 to 30 000 g/mol.

By methylhydroxy-(C₁-C₄)-alkylcellulose is meant methylhydroxy-(C₁-C₄)-alkylcellulose having any of a very wide variety of degrees of methylation and degrees of alkoxylation.

Methylhydroxy-(C₁-C₄)-alkylcelluloses are prepared in a known way by means of two reaction steps. In one step the cellulose is alkoxylated with alkylene oxides. In the second step the hydroxyl groups present are methylated with a methyl halide. These two reactions generally take place in succession but can also be carried out simultaneously. Depending on the stoichiometry of the alkylene oxides and alkylating agents used to the cellulose, there is variation in the degree of substitution of the cellulose. The average degree of substitution (DS) indicates the number of hydroxyl units of a dehydroglucose unit that have been etherified on average and can be from 0 to 3. The degree of molar substitution (MS) indicates the average number of alkoxy units per dehydroglycose unit and can also be greater than 3 as a result of the synthesis of side chains during the alkoxylation.

The preferred methylhydroxy-(C₁-C₄)-alkylcelluloses possess an average degree of substitution, DS, of 1.1 to 2.5 and a degree of molar substitution, MS, of 0.03 to 0.9.

Suitable methylhydroxy-(C₁-C₄)-alkylcelluloses are, for example, methylhydroxyethylcellulose or methylhydroxypropylcellulose. Particular preference is given to methylhydroxypropylcellulose.

The sequence of the metering of the SiO₂-based protective colloid and the methylhydroxy-(C₁-C₄)-alkylcellulose generally has no effect on the process and may take place jointly or separately.

The protective colloid comprising silica and optionally methylhydroxy-(C₁-C₄)-alkylcellulose can be considered part the capsule wall and is therefore likewise a constituent of the capsule wall.

Thus, it is normally possible for there to be up to 20, preferably up to 15% by weight, based on the total weight of the microcapsules, of protective colloid.

In general, the SiO₂-based protective colloid including any stabilizing polymer SP such as methylhydroxy-(C₁-C₄)-alkylcellulose, if applicable, are used in a total amount of 0.1% to 15% by weight, preferably of 0.5% to 10% by weight, based on the water phase. The stabilizing polymer SP, especially methylhydroxy-(C₁-C₄)-alkylcellulose, is used preferably in an amount of 0.05% to 2.5% by weight, more particularly of 0.1% to 2.0% by weight, based on the SiO₂-based protective colloid including any stabilizing polymer SP.

In addition, it is possible, as well as the SiO₂-based protective colloid and the optional methylhydroxy-(C₁-C₄)-alkylcellulose, to use further organic or inorganic protective colloids, in amounts less than 15% by weight, based on the total weight of the microcapsules. These further protective colloids, different than the protective colloids used in accordance with the invention, may be either organic or inorganic protective colloids, and may be ionic or neutral.

Organic neutral protective colloids are, for example, hydroxyethylcellulose, methylcellulose, and carboxymethylcellulose, polyvinylpyrrolidone, vinylpyrrolidone copolymers, gelatin, gum arabic, xanthan, casein, polyethylene glycols, polyvinyl alcohol, and partially hydrolyzed polyvinyl acetates.

Organic anionic protective colloids are sodium alginate, polymethacrylic acid and its copolymers, polyacrylic acid and its copolymers, the copolymers of sulfoethyl acrylate and methacrylate, of sulfopropyl acrylate and methacrylate, of N-(sulfoethyl)maleimide, and of 2-acrylamido-2-alkylsulfonic acids, styrenesulfonic acid, and vinylsulfonic acid. Preferred organic anionic protective colloids are naphthalenesulfonic acid and naphthalenesulfonic acid-formaldehyde condensates, and also, in particular, polyacrylic acids and phenolsulfonic acid-formaldehyde condensates.

A further possibility is to add surfactants for costabilization, preferably nonionic surfactants. Suitable surfactants can be found in the “Handbook of Industrial Surfactants”, whose content is expressly incorporated by reference. The surfactants can be used in an amount of 0.01% to 10% by weight, based on the water phase of the emulsion.

As free-radical initiators for the free-radical polymerization reaction it is possible to use the typical peroxo compounds and azo compounds, appropriately in amounts of 0.2% to 5% by weight, based on the weight of the monomers.

Depending on the aggregate state of the free-radical initiator and on its solubility behavior, it may be supplied as such, or preferably as a solution, emulsion or suspension, as a result of which it is possible to carry out more precise metering of, more particularly, small amounts of free-radical initiator substance.

Preferred free-radical initiators include tert-butyl peroxoneodecanoate, tert-amyl peroxypivalate, tert-amyl peroxy-2-ethylhexanoate, 2,2′-azobis-(2,4-dimethyl)valeronitrile, 2,2′-azobis(2-methylbutyronitrile), dibenzoyl peroxide, tert-butyl per-2-ethylhexanoate, di-tert-butyl peroxide, tert-butyl hydroperoxide, 2,5-dimethyl-2,5-di(tert-butylperoxy)hexane, and cumene hydroperoxide.

Particularly preferred free-radical initiators are di(3,5,5-trimethylhexanoyl) peroxide, 4,4′-azobisisobutyronitrile, tert-butyl perpivalate, dilauroyl peroxide, and dimethyl-2,2-azobisisobutyrate. These initiators have a half-life of 10 hours in a temperature range from 30 to 100° C.

Additionally, it is possible, for the polymerization, to add regulators known to the skilled worker, in typical quantities, such as tert-dodecylmercaptan or ethylhexyl thioglycolate.

The dispersing conditions for the preparation of the stable oil-in-water emulsion are preferably selected in conventional manner such that the oil droplets have the size of the desired microcapsules.

Generally speaking, the SiO₂-based protective colloid is alkali-stabilized. For the preparation of the oil-in-water emulsion it is advantageous to lower the pH of the emulsion, usually to a pH in the range of 2 to 7. According to one preferred embodiment the pH of the oil-in-water emulsion is adjusted to a level in the range of 1.5-4, preferably 2-3, more particularly approximately 2.5. This can be done by adding acids such as hydrochloric acid, sulfuric acid, nitric acid, formic acid or phosphoric acid.

The average particle size (particle diameter) d₅₀ of the microcapsules (determined according to ISO 13320, Particle Size Analysis—Laser Diffraction Methods, Dec. 1, 2009) is 0.1 to 100 μm, preferably 0.5 to 50 μm, more preferably 1 to 20 μm, and especially 2 to 15 μm.

The average particle size (particle diameter) d₉₀ of the microcapsules (determined according to ISO 13320, Particle Size Analysis—Laser Diffraction Methods, Dec. 1, 2009) is normally 0.1 to 100 μm, preferably 0.5 to 50 μm, more preferably 1 to 20 μm.

Another aspect of the present invention are processes for preparing microcapsules according to the invention, comprising the following steps:
A) Providing a water phase comprising disperse silica and optionally and optionally a stabilizer polymer SP, preferably a cellulose derivative C;
B) Providing an oil phase comprising at least one water immiscible solvent, at least one pesticide, preferably pyraclostrobin, a polymerizable monomer M and optionally at least one surfactant;
C) Emulsifying the oil phase obtained in step B) and the aqueous phase obtained in step A),
D) polymerizing said at least one polymerizable monomer M.

Typically, the process of the invention is carried out such that in a first step an aqueous phase is provided that comprises the disperse silica and optionally a cellulose derivative C such as methylhydroxy-(C₁-C₄)-alkylcellulose (step A)). The aqueous phase may further optionally comprise additives customarily used in dispersion processes or encapsulation processes, such as surfactants.

The oil phase normally comprises at least one water immiscible solvent as described above, at least one pesticide, preferably pyraclostrobin, a polymerizable monomer M and optionally at least one surfactant or other additives customarily used in dispersion processes or encapsulation processes.

Preferably said polymerizable monomer M is selected from at least one polyisocyanate or at least one ethylenically unsaturated monomer such as at least one (meth)acrylate as described above.

The oil phase is normally prepared separately from the aqueous phase.

Preferably the oil phase obtained in step in emulsified into the aqueous phase obtained in step A) to obtain an oil in water emulsion.

In another embodiment, the aqueous phase obtained in step a) is emulsified into the oil phase obtained in step B) to obtain a water in oil emulsion.

The process for preparing an emulsion of the oil phase and the aqueous phase (step C)) is carried out using methods known to the skilled person, for example by stirring with a rotor-stator device, such as an Ultraturrax.

After preparing the emulsion of the oil phase and the aqueous phase, the polymerizable monomer M is polymerized.

Preferably, said polymerization of said polymerizable monomer M is carried out by radical polymerization of ethylenically unsaturated monomers like (meth)acrylates or by reaction of at least one polyisocyanate with at least one polyamine.

In case polymerizable monomer M is a polyisocyanate, said polyisocyanate is in a preferred embodiment being reacted with a polyamine in step D). Suitable polyamines are described above. Said polyamine is normally added to the emulsion of the oil phase and the aqueous phase under stirring. It may be advantageous to heat the reaction mixture during or after the addition of the polyamine, for example to a temperature from 40 and 100° C.

Through the reaction of the polyamine and the polyisocyanate, capsules are formed that bear the pesticide, preferably pyraclostrobin, dissolved in the water immiscible solvent in the core of the capsule. The capsule is formed through the reaction of the polyisocyanate and the polyamine.

In case the polymerizable monomers M are ethylenically unsaturated monomers such as (meth)acrylates, such monomers are polymerized by radical polymerization in step D). This can be carried out by methods known to the skilled person, for example by adding radical initiators in step D).

Preferred free-radical initiators include tert-butyl peroxoneodecanoate, tert-amyl peroxypivalate, tert-amyl peroxy-2-ethylhexanoate, 2,2′-azobis-(2,4-dimethyl)valeronitrile, 2,2′-azobis(2-methylbutyronitrile), dibenzoyl peroxide, tert-butyl per-2-ethylhexanoate, di-tert-butyl peroxide, tert-butyl hydroperoxide, 2,5-dimethyl-2,5-di(tert-butylperoxy)hexane, and cumene hydroperoxide.

Particularly preferred free-radical initiators are di(3,5,5-trimethylhexanoyl) peroxide, 4,4′-azobisisobutyronitrile, tert-butyl perpivalate, dilauroyl peroxide, and dimethyl-2,2-azobisisobutyrate. These initiators have a half-life of 10 hours in a temperature range from 30 to 100° C.

Additionally, it is possible for the polymerization, to add regulators known to the skilled worker, in typical quantities, such as tert-dodecylmercaptan or ethylhexyl thioglycolate.

The microcapsules are for example formed by subjecting the oil-in-water emulsion to free-radical polymerization by heating. Generally speaking, the polymerization is carried out at temperatures in the range from 20 to 120° C. and preferably from 40 to 95° C.

Appropriately the polymerization is performed under atmospheric pressure, though it is also possible to operate under reduced or slightly increased pressure, in the case, for example, of a polymerization temperature above 100° C.; in other words, approximately, in the range from 0.5 to 5 bars.

The polymerization reaction times are normally 1 to 10 hours, usually 2 to 5 hours.

During the polymerization reaction, at a conversion of 90% to 99% by weight, it is advantageous, generally speaking, largely to free the aqueous microcapsule dispersions from odorants, such as residual monomers and other volatile organic constituents. This can be achieved in conventional manner, physically by distillative removal (more particularly via steam distillation) or by stripping with an inert gas. It may also take place chemically, as described in WO 99/24525, advantageously by means of redox-initiated polymerization, as described in DE-A 44 35 423, DE-A 44 19 518, and DE-A 44 35 422.

In this way it is possible to prepare microcapsules having an average particle size in the range from 0.5 to 100 μm, it being possible to adjust the particle size in conventional manner via the energy input, e.g. through the shearing force, the stirring speed, and the concentration of the components of the capsules, especially of the protective colloid. Preference is given to microcapsules having an average particle size in the range from 0.5 to 50 μm, preferably 0.5 to 30 μm, more particularly 3 to 15 μm (Z-average by means of light scattering).

Steps A) to D) yield microcapsules comprising a core, a shell and a protective colloid of silica and optionally cellulose derivative C, as described above.

Another aspect of the invention are formulations comprising capsules according to the invention.

Formulations according to the invention normally comprise the microcapsules according to the invention dispersed in a solvent or a solvent mixture.

In one preferred embodiment, formulations according to the invention are aqueous. “Aqueous” as used herein shall mean that such formulations comprise a solvent or a solvent mixture and that said solvent mixture comprises at least 50 wt % more preferably at least 70 wt % of water. The water immiscible solvent comprised in the capsule core shall not be considered therefore. In one preferred embodiment, the solvent comprises at least 95 wt % or at least 99 wt % of water.

Further formulation auxiliaries may be added to the formulation before, during or after the polymerization reaction. Such further formulation auxiliaries include solid carriers or fillers, surfactants, dispersants, emulsifiers, wetters, adjuvants, solubilizers, penetration enhancers, adhesion agents, thickeners, humectants, repellents, attractants, feeding stimulants, compatibilizers, bactericides, anti-freezing agents, anti-foaming agents, colorants, tackifiers and binders.

Suitable solid carriers or fillers are mineral earths, e.g. silicates, silica gels, talc, kaolins, limestone, lime, chalk, clays, dolomite, diatomaceous earth, bentonite, calcium sulfate, magnesium sulfate, magnesium oxide; polysaccharides, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, non-ionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.)

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable non-ionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a neglectable or even no pesticidal activity themselves, and which improve the biological performance of the compound I on the target. Examples are surfactants, mineral or vegetable oils, and other auxiliaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), inorganic clays (organically modified or unmodified), polycarboxylates, and silica or silicates.

Suitable bactericides are bronopol and isothiazolinone derivatives such as alkylisothiazolinones and benzisothiazolinones.

Suitable anti-freezing agents are ethylene glycol, propylene glycol, urea and glycerin.

Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

Suitable tackifiers or binders are polyvinylpyrrolidones, polyvinylacetates, polyvinyl alcohols, polyacrylates, biological or synthetic waxes, and cellulose ethers.

Formulations according to the invention normally comprise nonionic, anionic and/or cationic surfactants, preferably non-ionic and/or anionic surfactants.

The agrochemical formulations according to the generally comprise between 0.01 and 95%, preferably between 0.1 and 90%, and in particular between 0.5 and 75%, by weight of pesticidally active substance, preferably including pyraclostrobin.

The formulations according to the invention yield, after two-to-tenfold dilution, active substance concentrations of from 0.01 to 60% by weight, preferably from 0.1 to 40% by weight, in the ready-to-use preparations. Application can be carried out before or during sowing. Methods for applying formulations according to the invention on to plant propagation material, especially seeds include dressing, coating, pelleting, dusting, soaking and in-furrow application methods of the propagation material. Preferably, compound I or the formulations thereof, respectively, are applied on to the plant propagation material by a method such that germination is not induced, e. g. by seed dressing, pelleting, coating and dusting.

When employed in plant protection, the amounts of active substances applied are, depending on the kind of effect desired, from 0.001 to 2 kg per ha, preferably from 0.005 to 2 kg per ha, more preferably from 0.05 to 0.9 kg per ha, and in particular from 0.1 to 0.75 kg per ha.

In one embodiment formulations according to the invention are applier foliar.

In treatment of plant propagation materials such as seeds, e. g. by dusting, coating or drenching seed, amounts of active substance of from 0.1 to 1000 g, preferably from 1 to 1000 g, more preferably from 1 to 100 g and most preferably from 5 to 100 g, per 100 kilogram of plant propagation material (preferably seeds) are generally required.

When used in the protection of materials or stored products, the amount of active substance applied depends on the kind of application area and on the desired effect. Amounts customarily applied in the protection of materials are 0.001 g to 2 kg, preferably 0.005 g to 1 kg, of active substance per cubic meter of treated material.

Various types of oils, wetters, adjuvants, fertilizer, or micronutrients, and further pesticides (e.g. herbicides, insecticides, fungicides, growth regulators, safeners) may be added to the active substances or the formulations comprising them as premix or, if appropriate not until immediately prior to use (tank mix). These agents can be admixed with the formulations according to the invention in a weight ratio of 1:100 to 100:1, preferably 1:10 to 10:1.

The user applies the formulation according to the invention usually from a predosage device, a knapsack sprayer, a spray tank, a spray plane, or an irrigation system. Usually, the agrochemical formulation is made up with water, buffer, and/or further auxiliaries to the desired application concentration and the ready-to-use spray liquor or the agrochemical formulation according to the invention is thus obtained. Usually, 20 to 2000 liters, preferably 50 to 400 liters, of the ready-to-use spray liquor are applied per hectare of agricultural useful area.

According to one embodiment, individual components of the formulation according to the invention such as parts of a kit or parts of a binary or ternary mixture may be mixed by the user himself in a spray tank and further auxiliaries may be added, if appropriate.

Another aspect of the present invention are methods for controlling pests, especially phytopathogenic fungi, where the microcapsules according to the invention or the formulations according to the invention are allowed to act on the particular pests, especially such phytopathogenic fungi, their habitat or the plants to be protected from the particular fungi or their habitat or the soil.

The present invention offers the following advantages:

Capsules and formulations according to the invention are easy and economical to make. They are environmentally friendly.

Capsules according to the invention have a release profile that allows for efficient control of phytopathenic pests, especially fungi, while at the same time causing minimal undesired side effects. For example, the concentration of free pesticide from the uncontrolled release from the capsules is very low upon spraying of formulations comprising capsules according to the invention. The release of pesticide in the presence of nonionic surfactants is very low. This leads to a low concentration of free pesticide, especially pyraclostrobin, in the aqueous phase during and shortly after its application, for example in tank mix applications. This low release rate in aqueous environment improves the toxicological profile of such formulations and minimizes undesired side effects, for example its toxicity against amphibians.

### EXAMPLES

Materials used

| | |
|---|---|
| Surfactant A | C16/C18 alkyl ether alkoxylate |
| Surfactant B | C12/14 alcohol, ethoxylated, propoxylated |
| Silica A | Silica having a specific surface area |
| | (N2, multipoint following ISO 9277) |
| | of 180 m2/g, a particle size (d50, laser |
| | diffraction following ISO 13320:2009) of 14.0 μm, |
| | loss on drying (2 h at 105°, following ISO 787-2) |
| | of <= 7.0%, pH value of 6.5, sieve residue 45 μm |
| | (spray following ISO 3262-19) of <= 1.5% |
| Biocide A | aqueous solution comprising 2.5 wt % |
| | methylisothiazolinone and 2.5 wt % |
| | benzisothiazolinone |
| Polyisocyanate A | Oligomer of MDI with an isocyanate |
| | content of 31.5 g/100 g, viscosity at 25° C. |
| | according to DIN 53 018: 180-250 mPa*s |
| Solvent A | Aromatic hydrocarbon fluid having an initial |
| | boiling point of 247° C. and a final boiling |
| | point of 301° C. (ASTM D86) |
| Inorganic Clay A | disk-shaped crystals 25 nm in diameter of |
| | synthetic layered silicate (85-90 wt %) and |
| | tetrasodium pyrophosphate (7-10 wt. %) |
| Cellulose | Methylhydroxypropylcellulose with an |
| Derivative A | average molecular mass MW of 25 kDa and |
| | a viscosity in a 2 wt % aqueous solution at |
| | 21° C. of 450 mPas. |

### Example 1

Water Phase:

563.35 g DI water (DI=fully deionized water)

80.00 g of a 50% strength by weight silica sol (specific surface area ca. 80 m2/g)

12.00 g of a 5% strength by weight aqueous solution of Cellulose Derivative A

1.60 g of a 2.5% strength by weight aqueous sodium nitrite solution

12.00 g of a 20% strength by weight nitric acid solution in water

Feed 1

204.00 g Solvent A

136.00 g Pyraclostrobin

36.00 g methyl methacrylate

24.00 g pentaerythritol triacrylate

Feed 2:

0.80 g tert-butylperpivalate

Feed 3:

30.00 g of a 2% strength by weight aqueous solution sodium peroxodisulfate

Feed 4:

1.31 g of a 25% strength by weight aqueous solution of sodium hydroxide

Feed 5:

2.29 g Xanthan gum

11.43 1,2-propane diol

2.29 g DI water

The water phase above was introduced at 25° C. Feed 1 was added and the mixture was dispersed for 40 minutes at 3500 rpm. Following the introduction of feed 2, the reaction batch was heated to 67° C. in 60 minutes and then further heated to 90° C. in 60 minutes. Then, while holding the temperature constant at 90° C., feed 3 was added in 90 minutes. Afterwards, the temperature was held constant at 90° C. for another 60 minutes. The dispersion was then cooled to room temperature and feed 4 and feed 5 was added. The size of the capsules obtained is displayed in Table 1.

### Example 2

Water Phase:

564.60 g DI water (DI=fully deionized water)

200.00 g of a 50% strength by weight silica sol (specific surface area ca. 80 m2/g)

12.00 g of a 5% by weight aqueous solution Cellulose Derivative A

1.60 g of a 2.5% strength by weight aqueous sodium nitrite solution

12.00 g of a 20% strength by weight nitric acid solution in water

Feed 1

168.00 g Solvent A

112.00 g Pyraclostrobin

48.00 g methyl methacrylate

24.00 g pentaerythritol triacrylate

24.00 g 1,4-butane diol diacrylate

24.00 g methacrylic acid

Feed 2:

1.60 g tert-butylperpivalate

Feed 3:

60.00 g of a 2% strength by weight aqueous solution sodium peroxodisulfate

Feed 4:

5.71 g of a 25% strength by weight aqueous solution of sodium hydroxide

Feed 5:

2.50 g Xanthan gum

12.50 1,2-propane diol

2.5 g DI water

The water phase above was introduced at 25° C. Feed 1 was added and the mixture was dispersed for 40 minutes at 3500 rpm. Following the introduction of feed 2, the reaction batch was heated to 67° C. in 60 minutes and then further heated to 90° C. in 60 minutes. Then, while holding the temperature constant at 90° C., feed 3 was added in 90 minutes. Afterwards, the temperature was held constant at 90° C. for another 60 minutes. The dispersion was then cooled to room temperature and feed 4 and feed 5 was added. The size of the capsules obtained is displayed in Table 1.

### Example 3

Water Phase:

396.68 g DI water (DI=fully deionized water)

53.00 g of a 50% strength by weight silica sol (specific surface area ca. 80 m2/g)

7.95 g of a 5% strength by weight aqueous solution of Cellulose Derivative A

1.06 g of a 2.5% strength by weight aqueous sodium nitrite solution

1.65 g of a 20% strength by weight nitric acid solution in water

Feed 1

114.88 g Solvent A

76.58 g Pyraclostrobin

33.79 g Surfactant A

9.94 g methyl methacrylate

9.94 g methacrylic acid

10.14 g 2-hydroxy ethyl methacrylate

10.14 g ethylene glycol dimethacrylate

Feed 2:

0.53 g tert-butylperpivalate

Feed 3:

19.88 g of a 2% strength by weight aqueous solution sodium peroxodisulfate

Feed 4:

2.00 g Xanthan gum

1.60 g Biocide A (5% by weight)

40.00 g glycerin

123.2 g DI water

Feed 5:

85.00 g Surfactant B

4.25 g Silica A

Feed 6:

0.90 g of a 25% strength by weight aqueous solution of sodium hydroxide

The water phase above was introduced at 25° C. Feed 1 was added and the mixture was dispersed for 40 minutes at 3500 rpm. Following the introduction of feed 2, the reaction batch was heated to 67° C. in 60 minutes and then further heated to 90° C. in 60 minutes. Then, while holding the temperature constant at 90° C., feed 3 was added in 90 minutes. Afterwards, the temperature was held constant at 90° C. for another 60 minutes. The dispersion was then cooled to room temperature and feed 4, feed 5 and feed 6 was added. The size of the capsules obtained is displayed in Table 1.

### Example 4

Water Phase:

396.68 g DI water (DI=fully deionized water)

53.00 g of a 50% strength by weight silica sol (specific surface area ca. 80 m2/g)

7.95 g of a 5% strength by weight aqueous solution of Cellulose Derivative A

1.06 g of a 2.5% strength by weight aqueous sodium nitrite solution

1.65 g of a 20% strength by weight nitric acid solution in water

Feed 1

114.88 g Solvent A

76.58 g Pyraclostrobin

33.79 g Surfactant A

15.90 g methyl methacrylate

7.95 g pentaerythritol triacrylate

7.95 g 1,4-butane diol diacrylate

7.95 g methacrylic acid

Feed 2:

0.53 g tert-butylperpivalate

Feed 3:

19.88 g of a 2% strength by weight aqueous solution sodium peroxodisulfate

Feed 4:

2.00 g Xanthan gum

1.60 g Biocide A (5% by weight)

40.00 g glycerin

123.2 g DI water

Feed 5:

85.00 g Surfactant B

4.25 g Silica A

Feed 6:

1.80 g of a 25% strength by weight aqueous solution of sodium hydroxide

The water phase above was introduced at 25° C. Feed 1 was added and the mixture was dispersed for 40 minutes at 3500 rpm. Following the introduction of feed 2, the reaction batch was heated to 67° C. in 60 minutes and then further heated to 90° C. in 60 minutes. Then, while holding the temperature constant at 90° C., feed 3 was added in 90 minutes. Afterwards, the temperature was held constant at 90° C. for another 60 minutes. The dispersion was then cooled to room temperature and feed 4 and feed 5 was added. The size of the capsules obtained is displayed in Table 1.

### Example 5

Water Phase:

658.00 g DI water (DI=fully deionized water)

90.00 g of a 50% strength by weight silica sol (specific surface area ca. 80 m2/g)

13.50 g of a 5% strength by weight aqueous solution of Cellulose Derivative A

9.87 g of a 50% strength by weight citric acid in water

Feed 1

195.08 g Solvent A

130.05 g Pyraclostrobin

57.38 g Surfactant A

16.88 g methyl methacrylate

16.88 g methacrylic acid

17.22 g 2-hydroxy ethyl methacrylate

17.22 g ethylene glycol dimethacrylate

Feed 2:

0.90 g tert-butylperpivalate

Feed 3:

33.75 g of a 2% strength by weight aqueous solution sodium peroxodisulfate

Feed 4:

3.38 g Xanthan gum

2.70 g Biocide A (5% by weight)

67.60 g glycerin

208.52 g DI water

Feed 5:

143.91.00 g Surfactant B

7.19 g Silica A

Feed 6:

1.50 g of a 25% strength by weight aqueous solution of sodium hydroxide

The water phase above was introduced at 25° C. Feed 1 was added and the mixture was dispersed for 40 minutes at 3500 rpm. Following the introduction of feed 2, the reaction batch was heated to 67° C. in 60 minutes and then further heated to 90° C. in 60 minutes. Then, while holding the temperature constant at 90° C., feed 3 was added in 90 minutes. Afterwards, the temperature was held constant at 90° C. for another 60 minutes. The dispersion was then cooled to room temperature and feed 4 and feed 5 was added. The size of the capsules obtained is displayed in Table 1.

### Example 6

Water Phase:

668.00 g DI water (DI=fully deionized water)

90.00 g of a 50% strength by weight silica sol (specific surface area ca. 80 m2/g)

13.50 g of a 5% strength by weight aqueous solution of Cellulose Derivative A

17.00 g of a 50% strength by weight citric acid in water

Feed 1

206.4 g Solvent A

137.60 g Pyraclostrobin

60.75 g Surfactant A

11.25 g methyl methacrylate

11.25 g methacrylic acid

11.48 g 2-hydroxy ethyl methacrylate

11.48 g ethylene glycol dimethacrylate

Feed 2:

0.60 g tert-butylperpivalate

Feed 3:

22.50 g of a 2% strength by weight aqueous solution sodium peroxodisulfate

Feed 4:

3.38 g Xanthan gum

2.70 g Biocide A (5% by weight)

67.60 g glycerin

208.52 g DI water

Feed 5:

143.91.00 g Surfactant B

7.19 g Silica A

Feed 6:

1.50 g of a 25% strength by weight aqueous solution of sodium hydroxide

The water phase above was introduced at 25° C. Feed 1 was added and the mixture was dispersed for 40 minutes at 3500 rpm. Following the introduction of feed 2, the reaction batch was heated to 67° C. in 60 minutes and then further heated to 90° C. in 60 minutes. Then, while holding the temperature constant at 90° C., feed 3 was added in 90 minutes. Afterwards, the temperature was held constant at 90° C. for another 60 minutes. The dispersion was then cooled to room temperature and feed 4 and feed 5 was added. The size of the capsules obtained is displayed in Table 1.

### Example 7

Water Phase:

692.20 g DI water (DI=fully deionized water)

134.55 g of a 10% strength by weight aqueous solution of a polyvinyl alcohol with a molecular weight of Mw˜130 000 g/mol and a degree of hydrolysis of 88 mol %

Feed 1

194.40 g Solvent A

129.60 g Pyraclostrobin

57.38 g Surfactant A

16.88 g methyl methacrylate

16.88 g methacrylic acid

17.22 g 2-hydroxy ethyl methacrylate

17.22 g ethylene glycol dimethacrylate

Feed 2:

0.90 g tert-butylperpivalate

Feed 3:

33.75 g of a 2% strength by weight aqueous solution sodium peroxodisulfate

Feed 4:

3.38 g Xanthan gum

2.70 g Biocide A (5% by weight)

67.60 g glycerin

208.52 g DI water

Feed 5:

143.91.00 g Surfactant B

7.19 g Silica A

Feed 6:

1.50 g of a 25% strength by weight aqueous solution of sodium hydroxide

The water phase above was introduced at 25° C. Feed 1 was added and the mixture was dispersed for 40 minutes at 3500 rpm. Following the introduction of feed 2, the reaction batch was heated to 67° C. in 60 minutes and then further heated to 90° C. in 60 minutes. Then, while holding the temperature constant at 90° C., feed 3 was added in 90 minutes. Afterwards, the temperature was held constant at 90° C. for another 60 minutes. The dispersion was then cooled to room temperature and feed 4 and feed 5 was added. The size of the capsules obtained is displayed in Table 1.

### Example 8

Water Phase:

702.80 g DI water (DI=fully deionized water)

134.55 g of a 10% strength by weight aqueous solution of a polyvinyl alcohol with a molecular weight of Mw˜130 000 g/mol and a degree of hydrolysis of 88 mol %

Feed 1

205.86 g Solvent A

137.60 g Pyraclostrobin

60.75 g Surfactant A

11.25 g methyl methacrylate

11.25 g methacrylic acid

11.48 g 2-hydroxy ethyl methacrylate

11.48 g ethylene glycol dimethacrylate

Feed 2:

0.60 g tert-butylperpivalate

Feed 3:

22.50 g of a 2% strength by weight aqueous solution sodium peroxodisulfate

Feed 4:

3.38 g Xanthan gum

2.70 g Biocide A (5% by weight)

67.60 g glycerin

208.52 g DI water

Feed 5:

143.91.00 g Surfactant B

7.19 g Silica A

Feed 6:

1.50 g of a 25% strength by weight aqueous solution of sodium hydroxide

The water phase above was introduced at 25° C. Feed 1 was added and the mixture was dispersed for 40 minutes at 3500 rpm. Following the introduction of feed 2, the reaction batch was heated to 67° C. in 60 minutes and then further heated to 90° C. in 60 minutes. Then, while holding the temperature constant at 90° C., feed 3 was added in 90 minutes. Afterwards, the temperature was held constant at 90° C. for another 60 minutes. The dispersion was then cooled to room temperature and feed 4 and feed 5 was added. The size of the capsules obtained is displayed in Table 1.

### Example 9

Water Phase:

713.40 g DI water (DI=fully deionized water)

134.55 g of a 10% strength by weight aqueous solution of a polyvinyl alcohol with a molecular weight of Mw˜130 000 g/mol and a degree of hydrolysis of 88 mol %

Feed 1

217.29 g Solvent A

144.87 g Pyraclostrobin

63.91 g Surfactant A

5.61 g methyl methacrylate

5.61 g methacrylic acid

5.72 g 2-hydroxy ethyl methacrylate

5.72 g ethylene glycol dimethacrylate

Feed 2:

0.30 g tert-butylperpivalate

Feed 3:

11.25 g of a 2% strength by weight aqueous solution sodium peroxodisulfate

Feed 4:

3.38 g Xanthan gum

2.70 g Biocide A (5% by weight)

67.60 g glycerin

208.52 g DI water

Feed 5:

143.91.00 g Surfactant B

7.19 g Silica A

Feed 6:

1.50 g of a 25% strength by weight aqueous solution of sodium hydroxide

The water phase above was introduced at 25° C. Feed 1 was added and the mixture was dispersed for 40 minutes at 3500 rpm. Following the introduction of feed 2, the reaction batch was heated to 67° C. in 60 minutes and then further heated to 90° C. in 60 minutes. Then, while holding the temperature constant at 90° C., feed 3 was added in 90 minutes. Afterwards, the temperature was held constant at 90° C. for another 60 minutes. The dispersion was then cooled to room temperature and feed 4 and feed 5 was added. The size of the capsules obtained is displayed in Table 1.

### Example 10

Water Phase:

535.20 g DI water (DI=fully deionized water)

30.00 g of Inorganic Clay A

36.27 g of sodium chloride

Feed 1

137.70 g Solvent A

91.80 g Pyraclostrobin

40.50 g Surfactant A

7.50 g methyl methacrylate

7.50 g methacrylic acid

7.65 g 2-hydroxy ethyl methacrylate

7.65 g ethylene glycol dimethacrylate

Feed 2:

0.40 g tert-butylperpivalate

Feed 3:

15.00 g of a 2% strength by weight aqueous solution sodium peroxodisulfate

Feed 4:

3.38 g Xanthan gum

2.70 g Biocide A (5% by weight)

67.60 g glycerin

208.52 g DI water

Feed 5:

143.91.00 g Surfactant B

7.19 g Silica A

Feed 6:

1.50 g of a 25% strength by weight aqueous solution of sodium hydroxide

The water phase above was introduced at 25° C. Feed 1 was added and the mixture was dispersed for 40 minutes at 3500 rpm. Following the introduction of feed 2, the reaction batch was heated to 67° C. in 60 minutes and then further heated to 90° C. in 60 minutes. Then, while holding the temperature constant at 90° C., feed 3 was added in 90 minutes. Afterwards, the temperature was held constant at 90° C. for another 60 minutes. The dispersion was then cooled to room temperature and feed 4 and feed 5 was added. The size of the capsules obtained is displayed in Table 1.

### Example 11

For formulations obtained in examples 1 to 10, the average size (d50) of the microcapsules was determined by laser diffraction according to ISO 13320, Particle Size Analysis—Laser Diffraction Methods, Dec. 1, 2009.

Furthermore, the formulations obtained in examples 1 to 10 were subjected to a release test according to the following procedure:

In a glass beaker, equipped with a magnetic stirrer, 100 ml of a 10% solution of an ethylene-oxide/propylene oxide block co-polymer surfactant in demineralized water was placed. To this solution 50 μl of the formulation were added and after 10 min an aliquot was taken for analysis of free pyraclostrobin. For this analysis, the aliquot was firstly filtered through a 22 μm syringe filter, then injected into an HPLC equipment for quantitative analysis of pyraclostrobin. The value obtained represents the released pyraclostrobin in a 10% surfactant solution after 10 minutes at room temperature (21° C.).

The results are shown in table 1:

TABLE 1
Analytical Results: Average d50 particle size and release
properties of capsules according to examples 1 to 10

| | | Release of |
|---|---|---|
| | | pesticide |
| | | according |
| | | to example 11 |
| | | [% of released |
| | | pesticide after |
| | D (50)/μm | 10 min]. |
| Example 1 | 9.73 | |
| Example 2 | 6.72 | |
| Example 3 | 12.26 | |
| Example 4 | 10.55 | |
| Example 5 | 8.94 | 0.60 |
| Example 6 | 10.24 | 1.30 |
| Example 7 | 4.00 | 59.8 |
| Example 8 | 2.50 | 75.3 |
| Example 9 | 2.04 | 94.8 |
| Example 10 | 5.03 | 14.3 |

### Example 12

Water Phase:

177.00 g DI water (DI=fully deionized water)

12.00 g of a 50% strength by weight silica sol (specific surface area ca. 80 m2/g)

3.60 g of a 5% strength by weight aqueous solution of Cellulose Derivative A

0.48 g of a 2.5% strength by weight aqueous sodium nitrite solution

0.49 g of a 20% strength by weight nitric acid solution in water

Feed 1

46.84 g Solvent A

46.94 g Pyraclostrobin

23.80 g Surfactant A

2.40 g Polyisocyanate A

Feed 2:

2.80 g of a 25% strength by weight aqueous solution of tetraethylene pentamine

The water phase above was introduced at 25° C. Feed 1 was added and the mixture was dispersed for 3 minutes at 21000 rpm. Afterwards, Feed 2 was added slowly. Subsequently, the mixture was heated to 80° C. in one hour and kept at that temperature for two hours. The dispersion was then cooled to room temperature. The size of the capsules obtained is displayed in Table 2.

### Example 13

Water Phase:

212.75 g DI water (DI=fully deionized water)

12.00 g of a 50% strength by weight silica sol (specific surface area ca. 80 m2/g)

3.60 g of a 5% strength by weight aqueous solution of Cellulose Derivative A

0.48 g of a 2.5% strength by weight aqueous sodium nitrite solution

0.49 g of a 20% strength by weight nitric acid solution in water

Feed 1

59.98 g Solvent A

39.98 g Pyraclostrobin

17.64 g Surfactant A

2.40 g Polyisocyanate A

Feed 2:

2.80 g of a 25% strength by weight aqueous solution of tetraethylene pentamine

Feed 3:

1.07 g Xanthan gum

0.86 g Biocide A (5% by weight)

21.46 g glycerin

66.11 g DI water

Feed 4:

42.93 g Surfactant B

2.15 g Silica A

0.64 g of a 50% strength by weight aqueous solution of citric acid

The water phase above was introduced at 25° C. Feed 1 was added and the mixture was dispersed for 3 minutes at 21000 rpm. Afterwards, Feed 2 was added slowly. Subsequently, the mixture was heated to 80° C. in one hour and kept at that temperature for two hours. The dispersion was then cooled to room temperature and feed 3 and feed 4 were added. The size of the capsules obtained is displayed in Table 2.

### Example 14

Water Phase:

588.50 g DI water (DI=fully deionized water)

40.00 g of a 50% strength by weight silica sol (specific surface area ca. 80 m2/g)

12.00 g of a 5% strength by weight aqueous solution of Cellulose Derivative A 1.60 g of a 2.5% strength by weight aqueous sodium nitrite solution

12.00 g of a 20% strength by weight nitric acid solution in water

Feed 1

235.2 g Solvent A

156.80 g Pyraclostrobin

8.00 g Polyisocyanate A

Feed 2:

9.30 g of a 25% strength by weight aqueous solution of tetraethylene pentamine

Feed 3:

1.67 g of a 50% strength by weight aqueous solution of citric acid

Feed 4:

2.20 g Xanthan gum

11.00 g 1,2-propane diol

2.20 g DI water

The water phase above was introduced at 25° C. Feed 1 was added and the mixture was dispersed for 40 minutes at 3500 rpm. Afterwards, Feed 2 was added slowly. Subsequently, the mixture was heated to 80° C. in one hour and kept at that temperature for two hours. The dispersion was then cooled to room temperature and feed 3 and feed 4 were added. The size of the capsules obtained is displayed in Table 2.

### Example 15

Water Phase:

149.60 g DI water (DI=fully deionized water)

30.00 g of a 50% strength by weight silica sol (specific surface area ca. 80 m2/g)

0.60 g of a 5% strength by weight aqueous solution of Cellulose Derivative A

0.60 g of a 20% strength by weight nitric acid solution in water

Feed 1

48.86 g Solvent A

46.94 g Pyraclostrobin

23.80 g Surfactant A

2.40 g Polyisocyanate A

Feed 2:

6.00 g sodium lignosulfonate

0.60 g of a 20% strength by weight nitric acid solution in water

Feed 3:

2.80 g of a 25% strength by weight aqueous solution of tetraethylene pentamine

The water phase above was introduced at 25° C. Feed 1 was added and the mixture was dispersed for 3 minutes at 26000 rpm. Then feed 2 was added and mixed in by dispersing for 2 minutes at 26000 rpm. Afterwards, Feed 3 was added slowly. Subsequently, the mixture was heated to 80° C. in one hour and kept at that temperature for two hours. The dispersion was then cooled to room temperature. The size of the capsules obtained is displayed in Table 2.

### Example 16

Water Phase:

217.55 g DI water (DI=fully deionized water)

6.0 g of polyvinylalcohol

0.48 g of a 2.5% strength by weight aqueous sodium nitrite solution

Feed 1

59.98 g Solvent A

39.98 g Pyraclostrobin

17.64 g Surfactant A

2.40 g Polyisocyanate A

Feed 2:

2.80 g of a 25% strength by weight aqueous solution of tetraethylene pentamine

Feed 3:

1.07 g Xanthan gum

0.86 g Biocide A (5% by weight)

21.46 g glycerine

66.11 g DI water

Feed 4:

42.93 g Surfactant B

2.15 g Silica A

0.64 g of a 50% strength by weight aqueous solution of citric acid

The water phase above was introduced at 25° C. Feed 1 was added and the mixture was dispersed for 3 minutes at 21000 rpm. Afterwards, Feed 2 was added slowly. Subsequently, the mixture was heated to 80° C. in one hour and kept at that temperature for two hours. The dispersion was then cooled to room temperature and feed 3 and feed 4 were added. The size of the capsules obtained is displayed in Table 2.

### Example 17

For formulations obtained in examples 12 to 16, the average size (d50) of the microcapsules was determined by laser diffraction according to ISO 13320, Particle Size Analysis—Laser Diffraction Methods, Dec. 1, 2009.

Furthermore, the formulations obtained in examples 12 to 16 were subjected to a release test according to the following procedure:

In a glass beaker, equipped with a magnetic stirrer, 100 ml of a 10% solution of an ethylene-oxide/propylene oxide block co-polymer surfactant in demineralized water was placed. To this solution 50 μl of the formulation were added and after 10 min an aliquot was taken for analysis of free pyraclostrobin. For this analysis, the aliquot was firstly filtered through a 22 μm syringe filter, then injected into an HPLC equipment for quantitative analysis of pyraclostrobin. The value obtained represents the released pyraclostrobin in a 10% surfactant solution after 10 minutes at room temperature (21° C.).

The results are shown in table 2:

TABLE 2
Analytical Results: Average d50 particle size and release
properties of capsules according to examples 12 to 16

| | | Release of |
|---|---|---|
| | | pesticide |
| | | according |
| | | to example 17 |
| | | [% of released |
| | | pesticide after |
| | D (50)/μm | 10 min]. |
| Example 12 | 14.00 | 0.80 |
| Example 13 | 10.72 | 23.9 |
| Example 14 | 16.40 | 0.2 |
| Example 15 | 4.38 | 19.4 |
| Example 16 | 8.01 | 84.1 |

1. A microcapsule comprising a shell and a core, wherein said core comprises a pesticide and a water immiscible solvent and wherein said shell comprises an organic polymer, wherein said microcapsule further comprises a protective colloid of silica particles.

2. The microcapsule according to claim 1, wherein said protective colloid comprises silica particles and a stabilizer polymer SP.

3. The microcapsule according to claim 1, wherein said stabilizer polymer SP is a cellulose derivative C.

4. The microcapsule according to claim 3, wherein said cellulose derivative C is a methylhydroxy-(C₁-C₄)-alkylcellulose.

5. The microcapsule according to claim 1, wherein said water immiscible solvent has a solubility in water of less than 2 g/l.

6. The microcapsule according to claim 1, wherein said pesticide is pyraclostrobin and wherein the core comprises pyraclostrobin in dissolved form.

7. The microcapsule according to claim 1, wherein said polymer shell comprises a polyurea or a polyacrylate.

8. The microcapsule according to claim 1, wherein said microcapsule has an average diameter d₉₀ of 0.1 μm to 50 μm.

9. A method for preparing a microcapsule according to claim 1, comprising:
A) providing a water phase comprising disperse silica and optionally a stabilizer polymer SP;
B) providing an oil phase comprising at least one water immiscible solvent, a pesticide, a polymerizable monomer M, and optionally at least one surfactant;
C) emulsifying phase B) into phase A); and
D) polymerizing said at least one polymerizable monomer M.

10. The method according to claim 9, wherein said polymerizable monomer M is selected from at least one polyisocyanate or at least one ethylenically unsaturated monomer.

11. The method according to claim 9, wherein said polymerization of said polymerizable monomer M is carried out by radical polymerization of at least one (meth)acrylate or by reaction of at least one polyisocyanate with at least one polyamine.

12. A formulation comprising the a microcapsule claim 1 dispersed in a solvent or a solvent mixture.

13. A method for controlling phytopathogenic fungi, where the microcapsules according to claim 1 are allowed to act on the phytopathogenic fungi, their habitat, or the plants to be protected from the phytopathogenic fungi or their habitat or the soil.

14. The method according to claim 9, wherein the pesticide is pyraclostrobin.
